(19) United States
(12) Patent Application Publication
(10) Pub. No.: US 2007/0167543 A1
(43) Pub. Date: Jul. 19, 2007

(54) Anti-bacterial additive

(76) Inventors: Arthur Schwesig, Dornbirn (AT); Tatjana Javor, Engerwitzdorf (AT)

Correspondence Address: THE WEBB LAW FIRM, P.C., 700 KOPPERS BUILDING, 436 SEVENTH AVENUE, PITTSBURGH, PA, 15219, US

(21) Appl. No.: 10/579,438

(22) PCT Filed: Nov. 17, 2004
(86) PCT No.: PCT/EP04/13219

§ 371 Date: Dec. 11, 2006

(30) Foreign Application Priority Data
Nov. 18, 2003 (DE) 103 54 245.0

(51) Int. Cl. C08K 5/34

(52) U.S. Cl. 524/100

(57) ABSTRACT

The invention relates to an anti-bacterial additive for melamine resins, in particular for melamine-formaldehyde or melamine-urea-formaldehyde resins. The additive has at least one borate salt and a quaternary ammonium compound as the anti-bacterial active ingredients. As a result of the small number of individual constituents, said additive can be easily incorporated into the melamine resin, is extremely compatible with the latter and has an effective, long-lasting anti-bacterial action.

The invention relates to an antibacterial additive for melamine resins in accordance with claim 1, to an antibacterial melamine resin in accordance with claim 16, to a process for producing such a melamine resin in accordance with claim 17, to an antibacterial laminate in accordance with claim 21, to a process for producing an antibacterial laminate in accordance with claim 22, and to the use of an antibacterial laminate in accordance with claim 24.

Melamine resins find diverse industrial application for example for the coating of surfaces or else for the production of decorative laminates. Among the melamine resins the greatest industrial significance is possessed by melamine-formaldehyde resins and melamine/urea-formaldehyde resins. Their excellent properties such as scratch resistance, flame retardation, chemical and mechanical stability, and their hardness make them extremely suitable for articles exposed to severe stresses and especially for surfaces in everyday use. Conventional applications of melamine resins are in the form, for example, of melamine resin laminates for floors or for kitchen surfaces.

In view of increasing worldwide need for such laminates and their use not least in areas where hygiene-critical conditions prevail, there is a demand for surfaces having antibacterial properties. By antibacterial is meant that the total germ count on the surface in question over a certain period of time is constant or even decreasing. Especially in densely populated regions with less than ideal epidemiological boundary conditions, in the domestic sector and in the public sector, antibacterial surfaces create the basis for a rise in quality of life and in the health of the population. Furthermore, in the area of hospitals and biolabs, for example, antibacterial surfaces afford additional security against contamination.

JP 61258079 A discloses antibacterial polyester fibers which comprise an antibacterial active substance plus melamine components or acrylic components containing alkylene glycol, and which exhibit a long-lasting antibacterial activity.

Known from the literature, additionally, are additives which make melamine resins antibacterial.

JP 08073702 A relates, for example, to antibacterial melamine resins which comprise a mixture of aluminum oxides, magnesium oxides and silicon oxides and also elemental silver and zinc as active antibacterial compound. In this way it is possible to attain antibacterial properties for up to 48 hours. The disadvantage of this additive is its short-lasting antibacterial property and the large number of individual antibacterial components; the greater the number of individual components added to a melamine resin, the more difficult it is to carry out optimum quantitative tailoring of all constituents of the resin liquor to one another.

JP 07329265 A likewise describes an antibacterial melamine resin, in the form of a decorative panel. An overlay paper is impregnated with an antibacterial melamine resin and then pressed with one or more core papers, impregnated with phenolic resin, to form a laminate. The melamine resin acquires its antibacterial properties through one of the components silver, benzalkonium, cetylpyridinium or isopropylmethylphenol. In order to make the antibacterial component compatible with the melamine resin it has to be applied in a separate processing step to a laminar phosphate support material. Only in this form can it be added to the melamine resin.

WO 03/009827 A1 relates to melamine resins which contain antimicrobial substances. The antimicrobial component in this case is a mixture of a diphenyl ether derivative and ortho-phenylphenol, a substance having an undesirably high vapor pressure, whose use is justified only in special cases. A disadvantage of this mixture is that it can be washed off easily from the resin surface, so that the antibacterial activity decreases with time.

Examples of further antibacterial components described include zinc or sodium pyrithions, azoles, hydrochloride, carbanilide, and also silver, copper and zinc in zeolite or amorphous glass powder. Since some of these components can react with the melamine resin, they must be encapsulated in a support material which is compatible with the melamine resin before they are added to the melamine resin, and this entails an additional and high level of expense in terms of labor.

U.S. Pat. No. 6,248,342 B1 describes antibacterial laminates in whose melamine-resin-impregnated surface an inorganic active antibacterial substance containing a metal ion has been incorporated. As active antibacterial substance preference is given to using zeolites which contain metal ions such as, for example, Ag, Cu, Zn, Hg, Sn, Pb, Bi, Cd, Cr or mixtures thereof. As a result of ion exchange processes, the metal ions pass to the laminate surface and so make the antibacterial activity possible. Disadvantages in this case are that the metal ions may be converted, during the ionic exchange process, into their oxides, hydroxides or other salts, a form in which they deposit on the laminate surface and hence attenuate the antibacterial activity there. A further disadvantage from a health standpoint is the use of heavy metals associated with employment of these zeolites.

The object which emerged, therefore, was that of developing an antibacterial additive for melamine resins that does not have the abovementioned disadvantages. Besides an effective and long-lasting antibacterial activity, an additive of this kind is subject to further requirements. It ought as far as possible to contain no health-hazard substances, and it ought not to impact adversely on the characteristic physical properties and processing properties of the melamine resin, such as impregnation characteristics and curing characteristics. Moreover, it ought to be very easy to incorporate the additive into the melamine resin. Furthermore, it ought to be compatible with the resin and to be incorporated lastingly in the melamine resin.

The present invention accordingly provides an antibacterial additive for melamine resins, particularly for melamine/formaldehyde or melamine/urea/formaldehyde resins, which is characterized in that it has at least one borate salt as active antibacterial compound, the borate salt being a salt of orthoboric acid H₃BO₃ and/or metaboric acid HBO₂ and/or of polyboric acids Hₙ₋₂BₙO₂ₙ₋₁, and has at least one quaternary ammonium compound of the formula 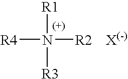
with R₁, R₂, R₃=C₁-C₅ alkyl, R₄=C₁-C₂₀ alkyl or benzyl, it being possible for R₁, R₂, R₃ and R₄ to be identical or different, and X=chloride or bromide.

An advantage of the antibacterial additive of the invention is that through the use of borate salts it is possible to minimize the number and the amount of the active compounds contained within the additive. In this way the quantitative tailoring to the other constituents of the melamine resin liquor is not a problem.

A further advantage of an antibacterial additive with at least one borate salt and at least one quaternary ammonium compound is the synergistic activity of the active antibacterial compounds. This means that, in order to achieve a defined antibacterial activity, a lower overall amount is necessary when using a mixture than when using the individual components. Furthermore, the active compounds of the additive that are employed are unobjectionable from a health standpoint.

Over and above these advantages, the active compounds are compatible with the melamine resin without further, additional operations such as, for example, encapsulation in or application to a support material. In the course of the operation of producing the laminate, the active compounds are incorporated firmly into the melamine resin and therefore allow the laminates to have a durably consistent antibacterial property.

The additive of the invention is used in particular for melamine-formaldehyde resins or urea/melamine-formaldehyde resins.

Further advantageous examples of melamine resins which can be used are those which form as a result of condensation of melamine or of mixtures of urea with melamine with aldehydes of chain lengths C₁-C₁₀. Mixtures of aldehydes of these chain lengths as well, such as formaldehyde, acetaldehyde, trimethylolacetaldehyde, acrolein, benzaldehyde, furfural, glyoxal, glutaraldehyde, phthalaldehyde, terephthalaldehyde, isobutyraldehyde, acetone or ketones, such as methyl ethyl ketone and diethyl ketone, for example, are also possible.

Examples of melamine resins are also those which are etherified by reaction with C₁-C₄ alcohols and subsequently, if desired, transetherified with C₄-C₁₈ alcohols. Melamine resins of this kind are described for example in WO 03/046053 A1.

A further possibility are those melamine resins which, following etherification, are subjected, for example, to partial transetherification with diols and/or to partial reaction with bisepoxides.

The advantage of modified melamine resins of this kind is that they can be processed by thermoplastic processing methods such as extrusion or injection molding, for example. In this way, with the antibacterial additive of the invention, it is possible to produce moldings having antibacterial properties. The melamine resins may comprise fillers and modifiers such as, for example, elasticizers and also curing agents, wetting agents, release agents or other customary additions.

The borate salts of orthoboric acid H₃BO₃, of metaboric acid HBO₂ or of polyboric acids Hₙ₋₂BₙO₂ₙ₋₁ are described, in the absence of a uniform nomenclature system, usually by way of empirical formulae, as for example via the number of cations and boron atoms in the simplest stoichiometric unit. Additionally, oxide formulae, or the names of the corresponding borate minerals, are used as features of description.

Borate salts used more preferably in the additive of the invention are those which can be described by the following formulae:
Mₐ B_{b} O_{c}*d H₂O and/or
Mₐ Nₐ B_{b} O_{c}*d H₂O, where
a, a′=1 or 2
b=1 to 8
c=1 to 13
d=0 to 10
M, N=NH₄, Na, K, Li, Ca, Mg, Zn, and where M, N, a and a′ may be identical or different.

Examples of possible borates in the additive of the invention are Na₂B₄O₇*dH₂O where d=0, 5 or 10; NaBO₂*dH₂O where d=2 or 4; NaB₅O₈*5H₂O; Na₂B₈O₁₃*4H₂O; Ca₂B₆O₁₁*5H₂O; NaCaB₅O₉*dH₂O where d=5 or 8; LiBO₂*8H₂O; LiB₅O₈*5H₂O; Li₂B₄O₇*3H₂O; K₂B₄O₇*4H₂O; KB₅O₈*4H₂O; NH₄B₅O₈*4H₂O; (NH₄)₂B₄O₇*4H₂O₇*4H₂O; Zn₂B₆O₁₁*dH₂O where d=3.5, 7-7.5, 9; ZnB₂O₄*2H₂O.

In one particularly preferred embodiment of the antibacterial additive of the invention at least one borate salt is technical zinc borate ZnO*B₂O₃*dH₂O or technical sodium borate Na₂O*B₂O₃*10H₂O, the technical zinc borate having ≧45% by weight ZnO and ≧36% by weight B₂O₃.

Particularly advantageous, additionally, is an antibacterial additive which has as its sole borate salt technical zinc borate ZnO*B₂O₃*dH₂O.

It is advantageous in this context if the amount of borate salt in the additive is 0.1 to 3% by weight, preferably 1% to 2.5% by weight, more preferably 1.8% to 2.2% by weight, based on the amount of solid melamine resin.

The advantage of these borate salts as active antibacterial compounds is that with them it is possible to obtain particularly good antibacterial properties in the melamine resin. A further advantage here is that the amount of active compound required for this purpose is low. A low amount of active compound is positive because the additive is then easy to manage from a technical standpoint—that is, it can be mixed well with the melamine resin.

In one particularly advantageous embodiment benzalkonium chloride is used as quaternary ammonium compound. Benzalkonium chloride is the term used for the substance alkylbenzyldimethylammonium chloride, R in the commercial product not having a unitary definition.

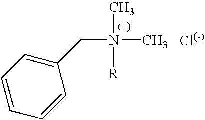

Benzalkonium chloride is a substance available on the market that is offered both in solid form and in liquid form. Hence, depending on the technical circumstances, such as the viscosity of the melamine resin used, for example, the optimum use form can be selected.

Particular preference is given to an antibacterial additive which has a mixture of technical zinc borate ZnO*B₂O₃*dH₂O and/or technical sodium borate Na₂O*B₂O₃*dH₂O with d=10 and benzalkonium chloride, the weight ratio of technical zinc borate and/or technical sodium borate:benzalkonium chloride in the melamine resin being advantageously 2:2:1.

It is further preferred if the amount of technical zinc borate ZnO*B₂O₃*3.5H₂O and/or technical sodium borate Na₂O*B₂O₃*10H₂O and the amount of benzalkonium chloride in the additive is 0.1 to 1% by weight, preferably 0.2 to 0.6% by weight, based on the amount of solid melamine resin.

With an additive of this kind the antibacterial activity is very good and at the same time the technical processing properties during laminate production are very good. When a sheetlike structure is impregnated with an antibacterial melamine resin comprising the additive it is critical that the active antibacterial compounds of the additive that are present in the melamine resin are distributed uniformly over the sheetlike structure. This is achieved to particularly good effect in the case of an embodiment in which the melamine resin comprises a mixture of zinc borate and/or sodium borate and benzalkonium chloride.

The present invention further provides an antibacterial melamine resin which comprises an antibacterial additive of the invention, and also provides a process for producing an antibacterial melamine resin of this kind.

In the course of the production of the antibacterial melamine resin of the invention a melamine resin present in dissolved form is mixed with the antibacterial additive of the invention using customary mixing equipment such as stirrers, for example. In this procedure it is important that the mixture of antibacterial additive and melamine resin is stirred thoroughly, to produce an extremely uniform antibacterial melamine resin suspension, in which the particles are held lastingly in suspension.

The melamine resin to which the additive is admixed is typically in the form of an aqueous or alcoholic solution.

The additive can be admixed to the melamine resin in solid and/or liquid form. It is possible to add the individual additive constituents individually or as a mixture of the constituents. The borate salt present in the additive may be admixed to the melamine resin together with and/or after and/or before the quaternary ammonium compound that may be present. Following the addition of additive it is possible, where appropriate, to add the curing agent, as the last component, to the melamine resin.

This gives an antibacterial melamine resin in suspended form, which subsequently can be processed further directly, as for laminate production, for example, or can be converted into the form of a solid resin by spray drying, for example, and can be passed on for its further processing at a later point in time.

Preference is given to an embodiment in which the antibacterial additive is admixed during the melamine resin synthesis. In this case the melamine resin precondensate obtained in the melamine resin synthesis is cooled and subsequently mixed with the additive. It is advantageous in this case that an antibacterial melamine resin can be produced directly from the raw materials for the resin synthesis, without an additional step of intermediate isolation of the melamine resin.

Additionally preferred is an embodiment in which the antibacterial additive is admixed to the melamine resin after the melamine resin synthesis. In this case the melamine resin may be present as a liquid resin in dissolved form or as a solid resin. If present as a solid resin, it is converted into the dissolved form before being mixed with the additive.

In the case of this embodiment it is advantageous that any melamine resin available on the market can be converted into an antibacterial melamine resin by a simple mixing with the additive of the invention.

The present invention further provides an antibacterial laminate comprising an antibacterial melamine resin, and also provides a process for producing an antibacterial laminate of this kind.

For laminate production at least one dry absorbent sheetlike structure is impregnated with the antibacterial melamine resin.

The absorbent sheetlike structure is in the form, for example, of paper, board, woven fabric or nonwoven, wood veneers, wood fiberboard or wood chipboard, and preferably comprises cellulose and/or lignocellulose.

The antibacterial melamine resin used for laminate production can be present in the form of solid resin or liquid resin, and is typically used in the form of an aqueous solution for laminate production. It may comprise further adjuvants such as, for example, wetting agents or release agents, plasticizers and curing agents, and other customary additions.

The application of antibacterial melamine resin, based on the sheetlike structure originally employed, is typically 110% to 130% by weight.

This produces an antibacterial sheetlike structure, which is dried prior to further processing.

The dried antibacterial sheetlike structure is subsequently pressed with at least one resin-impregnated sheetlike structure as an interlayer or with a support material such as chipboard panels, for example, under customary pressure and temperature conditions, to form a laminate, and in the course of this operation is fully cured.

In addition to the excellent materials properties and surface properties that are typical of melamine resin laminates, the antibacterial laminate obtained in this way exhibits excellent permanent antibacterial properties.

As a result of the antibacterial activity of the melamine resins of the invention against a very broad spectrum of bacteria and against very aggressive bacterial cultures, a diversity of possible applications are opened up. For example, antibacterial moldings can be produced from melamine resins which can be processed as thermoplastics. Furthermore, antibacterial compression-molding compounds can be produced. Moreover, the antibacterial laminates produced from the resins open up a diversity of possible applications. For instance, they can be used for furniture surfaces or floors in all areas where particular value is placed on hygienic conditions, such as in the bathroom or kitchen or else in hospitals, for example.

### EXAMPLE 1

Preparation of the Antibacterial Melamine Formaldehyde Resin

500 g of melamine/formaldehyde resin (Agrolinz Melamin Italia) are dissolved in 500 g of water, and then 3 g of the wetting agent Melpan NU02MF and 5 g of the curing agent Melpan A462 (conventional wetting agents and release agents from Agrolinz Melamin Italia) are added. This aqueous amino resin precondensate mixture is stirred until a clear solution is obtained.

This melamine resin solution is subsequently admixed with
10 g of technical zinc borate in the case of sample D and
2.5 g of technical zinc borate, 2.5 g of technical sodium borate and 1.25 g of benzalkonium chloride in the case of sample E
   and the additized solution is stirred for 10 minutes until a homogeneous suspension is formed.
   Production of the Antibacterial Laminate

This antibacterial melamine resin suspension is used to impregnate white decorative paper (density: 80 g/m²). The impregnated decorative paper is subsequently dried in air for 1 hour and then in a drying cabinet at 120° C. for 90 seconds until the residual moisture content is approximately 7-8% by weight. This single impregnation gave a total resin add-on of approximately 120-130% by weight, based on the mass of the dry white decorative paper originally employed.

This decorative paper, impregnated with antibacterial melamine/formaldehyde resin, is pressed with four plies of a core kraft paper impregnated with a melamine/formaldehyde resin and of a balancing paper likewise impregnated with a melamine/formaldehyde resin, to form a multilayer laminate. The pressing conditions employed are as follows: pressing time 2 min, pressing temperature 150° C., pressing pressure 80 kg/cm², back-cooling to 70° C.

The antibacterial laminate thus obtained has a lustrous and transparent surface.

Investigation of Antibacterial Activity

As a measure of the antibacterial activity the resistance of Gram-positive and Gram-negative bacteria is investigated. The antimicrobial activity of antibacterial melamine/formaldehyde resin over a time period of 24 hours was initially tested on thirteen bacterial species and one yeast. The bacterial species were Escherichia coli 14, Klebsiella pneumoniae 13, Proteus vulgaris 14, Salmonella typhi 1, Staphylococcus aureus 5, Enterococcus faecalis 1, Streptococcus pyogenes A22, Pseudomonas aeruginosa, Staphylococcus saprophyticus, Staphyloccus haemoliticus, Pseudomonas fluorescens, Staphylococcus epidermis and Vibrio parahaemoliticus. The yeast was Candida albicans 494 variety.

The bacterial species used in this antimicrobial study had been isolated from human infections.

To investigate the antimicrobial activity the method used was the film contact method in modified form. Each sample was grown in a tryptic soy broth in order to achieve a microbe count of 10⁹ colony-forming units (CFUs) per ml. These cultures were subsequently diluted with sterile phosphate buffers, to give test cultures of approximately 10⁵ CFUs/ml. Comparable amounts of the dilute broth cultures were subsequently applied to the following samples:
1) Nutrient agar in a Petri dish (control specimen)
2) Standard melamine resin sample A (contains no antibacterial additive)
3) Antibacterial melamine/formaldehyde resin sample D
4) Antibacterial melamine/formaldehyde resin sample E

After 0, 4, 8 and 24 hours the samples of the applied cultures were removed, diluted successively in a ratio of 1:10, 1:100 and 1:1000, and then placed on Mueller Hinton agar (DIFCO) and Sabouraud dextrose agar (only in the case of Candida albicans), in order to determine the reduction in viable bacteria as CFUs.

Results

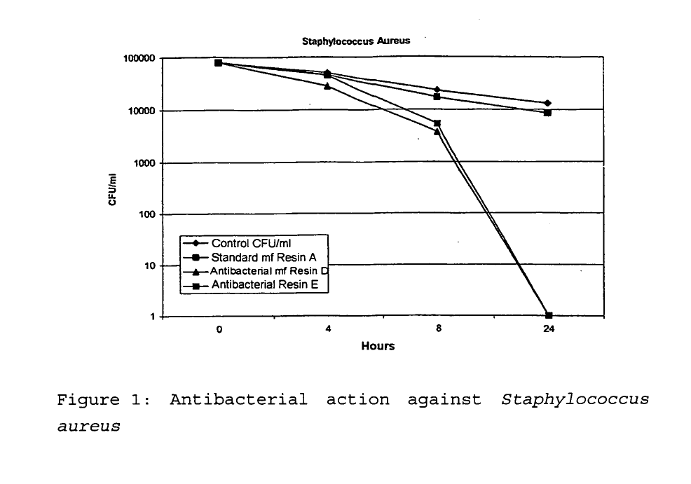

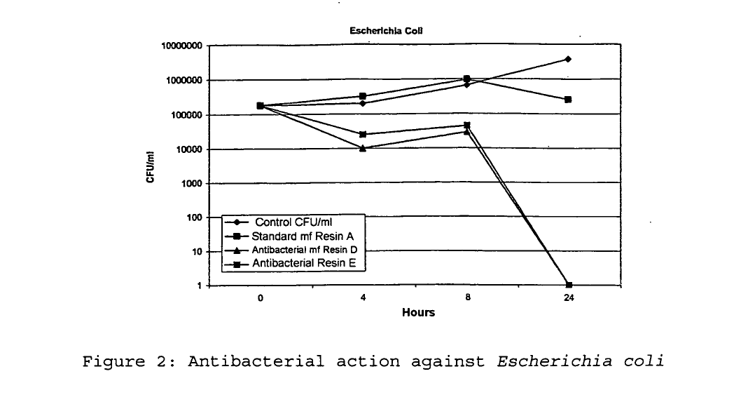

The results of the antibacterial activity of the additized melamine/formaldehyde resins for Staphylococcus aureus and Escherichia coli bacteria are depicted in FIGS. 1 and 2. The samples shown are samples D and E, sample D containing zinc borate and sample E zinc borate, sodium borate, and benzalkonium chloride as active antibacterial compounds. From FIGS. 1 and 2 it is apparent that when the borates of the invention are used as antibacterial additives (samples D and E), a significantly more rapid decrease in the bacterial concentration in the melamine/formaldehyde resin occurs than is the case in the unadditized melamine/formaldehyde resin (standard MF Resin A).

This is proved, as apparent from the figures, for different bacteria species such as, for example, Staphylococcus aureus and Escherichia coli.

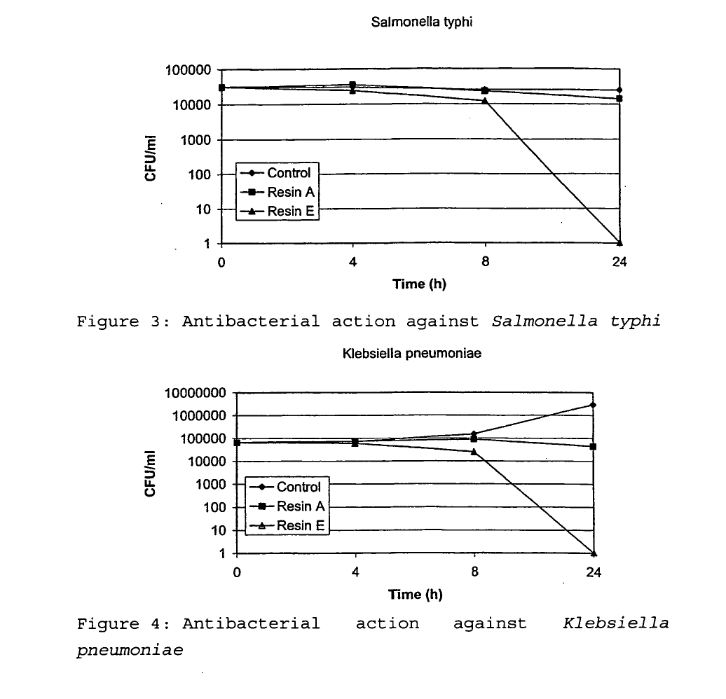

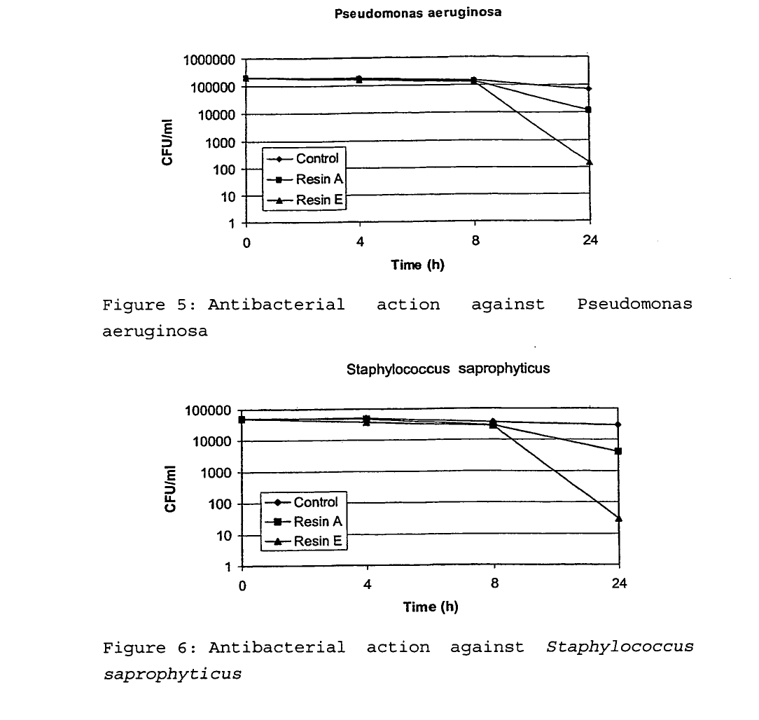

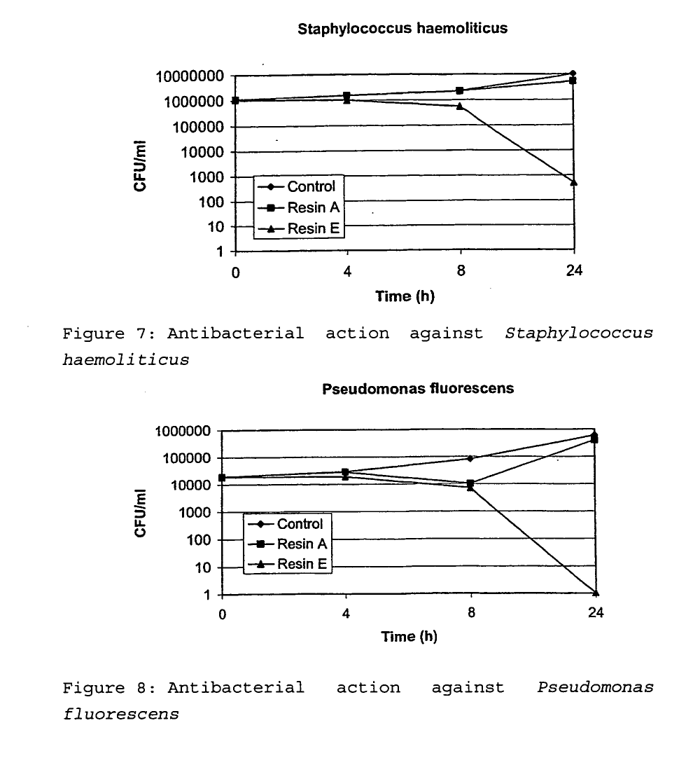

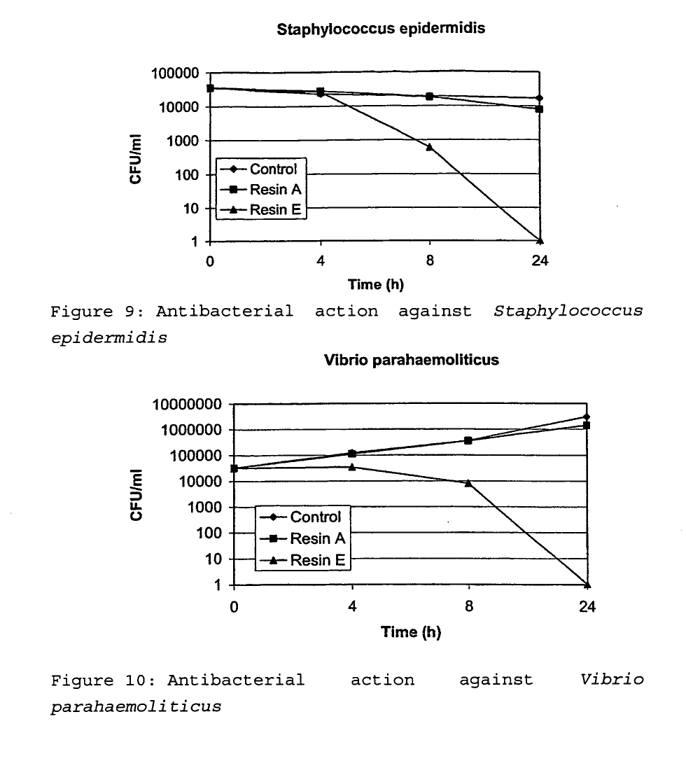

FIGS. 3 to 10 depict the antibacterial activity of the additives in sample E against a wide variety of bacterial species.

Sample E was produced with the same method as described in example 1 under “Preparation of the antibacterial melamine/formaldehyde resin”. The sole difference was that the curing agent was added to the melamine resin as the last component, in other words after the additive had been added.

It is apparent that the additive of the invention leads to a rapid decrease in bacterial concentration across all bacterial species as compared with a melamine/formaldehyde resin not treated with the additive.

1-27. (canceled)

28. An antibacterial additive for melamine resins, comprising at least one borate salt selected from the group consisting of the salts of orthoboric acid H₃BO₃, of metaboric acid HBO₂ and of polyboric acids Hₙ₋₂BₙO₂ₙ₋₁ as active antibacterial compound and, further comprising at least one quaternary ammonium compound of the formula 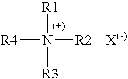
with R₁, R₂, R₃=C₁-C₅ alkyl, R4=C₁-C₂₀ alkyl or benzyl, it being possible for R₁, R₂, R₃ and R4 to be identical or different, and X=chloride or bromide, wherein
at least one borate salt is of the formula ZnₐB_{b}O_{c}*dH₂O with a=1 or 2, b=1 to 8; c=1 to 13 and d=0 to 10.

29. The antibacterial additive for melamine resins of claim 28, wherein the melamine resins are formed by condensation of melamine, or of mixtures of urea with melamine with aldehydes, or of mixtures of aldehydes, including formaldehyde, acetaldehyde, trimethylolacetaldehyde, acrolein, benzaldehyde, furfural, glyoxal, glutaraldehyde, phthalaldehyde, terephthalaldehyde, and isobutyraldehyde, or of acetone, or of ketones, including methyl ethyl ketone and diethyl ketone.

30. The antibacterial additive for melamine resins of claim 28, wherein the melamine resins are etherified by reaction with C₁-C₄ alcohols, or etherified by reaction with C₁-C₄ alcohols and subsequently transetherified with C₄-C₁₈ alcohols or diols or both, or etherified by reaction with C₁-C₄ alcohols and partly reacted with bisepoxides.

31. The antibacterial additive for melamine resins of claim 28, further comprising at least one borate salt of the formulae
Mₐ B_{b} O_{c}*dH₂O or
MₐN_{a′}B_{b}O_{c}*dH₂O, where
a, a′=1 or 2
b=1 to 8
c=1 to 13
d=0 to 10
M, N=NH₄, Na, K, Li, Ca, Mg and where M, N, a and a′ may be identical or different.

32. The antibacterial additive of claim 31, wherein at least one borate salt is Na₂B₄O₇*dH₂O where d=0, 5 or 10; NaBO₂*dH₂O where d=2 or 4; NaB₅O₈*5H₂O; Na₂B₈O₁₃*4H₂O; Ca₂B₆O₁₁*5H₂O; NaCaB₅O₉*dH₂O where d=5 or 8; LiBO₂*8H₂O; LiB₅O₈*5H₂O; Li₂B₄O₇*3H₂O; K₂B₄O₇*4H₂O; KB₅O₈*4h₂O; NH₄B₅O₈*4H₂O; (NH₄)₂B₄O₇*4H₂O₇*4H₂O; Zn₂B₆O₁₁*dH₂O where d=3.5, 7-7.5, 9; or ZnB₂O₄*2H₂O.

33. The antibacterial additive of claim 28, wherein at least one borate salt is technical zinc borate ZnO*B₂O₃*dH₂O with ≧45% by weight ZnO and ≧36% by weight B₂O₃.

34. The antibacterial additive of claim 28, wherein at least one borate salt is technical sodium borate Na₂O*B₂O₃*10H₂O.

35. The antibacterial additive of claim 28, wherein the only sole borate salt is technical zinc borate ZnO*B₂O₃*dH₂O.

36. The antibacterial additive of claim 33, wherein the amount of borate salt is 0.1 % to 3% by weight, based on the amount of solid melamine resin.

37. The antibacterial additive of claim 33, wherein the amount of borate salt is 1% to 2.5% by weight, based on the amount of solid melamine resin.

38. The antibacterial additive of claim 33, wherein the amount of borate salt is 1.8% to 2.2% by weight, based on the amount of solid melamine resin.

39. The antibacterial additive of claim 28, wherein at least one quaternary ammonium compound is benzalkonium chloride.

40. The antibacterial additive of claim 39, comprising technical zinc borate ZnO*B₂O3*dH₂O and benzalkonium chloride in a weight ratio of 2:1.

41. The antibacterial additive of claim 40, wherein the amount of technical zinc borate and benzalkonium chloride is 0.1% to 1% by weight, based on the amount of solid melamine resin.

42. The antibacterial additive of claim 40, wherein the amount of technical zinc borate and benzalkonium chloride is 0.2% to 0.6% by weight, based on the amount of solid melamine resin.

43. The antibacterial additive of claim 39, comprising technical zinc borate ZnO*B₂O₃*dH₂O and technical sodium borate Na₂O*B₂O₃*dH₂O with d=10 and benzalkonium chloride in a weight ratio of 2:2:1.

44. The antibacterial additive of claim 43, wherein the amount of technical zinc borate and technical sodium borate and benzalkonium chloride is 0.1% to 1% by weight, based on the amount of solid melamine resin.

45. The antibacterial additive of claim 43, wherein the amount of technical zinc borate and technical sodium borate and benzalkonium chloride is 0.2% to 0.6% by weight, based on the amount of solid melamine resin.

46. An antibacterial melamine resin comprising an antibacterial additive of claim 28.

47. A process for producing an antibacterial melamine resin, wherein an antibacterial additive of claim 28 is mixed with a melamine resin present in dissolved form, the additive being admixed to the melamine resin in solid or liquid form or both to give an antibacterial melamine resin in suspended form which subsequently, directly or following conversion into a solid resin, is processed further at a later point in time.

48. The process of claim 47, wherein the antibacterial additive is admixed during the melamine resin synthesis after the melamine resin precondensate obtained in the melamine resin synthesis has cooled.

49. The process of claim 47, wherein the antibacterial additive is admixed after the melamine resin synthesis, the admixing taking place to a melamine resin present in dissolved form as a liquid resin, or, where a solid resin is present, the admixing taking place after the solid resin has been converted into the dissolved form.

50. The process of claim 47, wherein the borate salt present in the additive is mixed with the melamine resin together with or after or before the quaternary ammonium compound.

51. An antibacterial laminate comprising an antibacterial melamine resin of claim 28.

52. A process for producing an antibacterial laminate, wherein:
a. a dry absorbent sheetlike structure is impregnated with the antibacterial melamine resin of claim 28 present in dissolved form,
b. the antibacterial sheetlike structure thus obtained is dried, and
c. the dried antibacterial sheetlike structure is pressed with one or more resin-impregnated interlayers or with a support material to form a laminate, and is fully cured.

53. The process of claim 52, wherein the melamine resin comprises further additives, including wetting agents, release agents, plasticizers, curing agents, or other customary additions.
